(19) United States
(12) Patent Application Publication
(10) Pub. No.: US 2014/0060185 A1
(43) Pub. Date: Mar. 6, 2014

(54) Device for Measuring a Yaw Rate

(71) Applicants: Stefan Rombach, Merdingen (DE); Thomas Northemann, Gerlingen (DE); Michael Maurer, Rheinhausen (DE); Mattias Dienger, Freiburg (DE); Yiannos Manoli, Freiburg (DE)

(72) Inventors: Stefan Rombach, Merdingen (DE); Thomas Northemann, Gerlingen (DE); Michael Maurer, Rheinhausen (DE); Mattias Dienger, Freiburg (DE); Yiannos Manoli, Freiburg (DE)

(73) Assignees: HAHN-SCHICKARD-GESELLSCHAFT FUR ANGEWANDTE FORSCHUNG E.V., Villingen-Schwenningen (DE); ALBERT-LUDWIGS-UNIVERSITÄT FREIBURG, Freiburg (DE)

(21) Appl. No.: 13/990,583

(22) PCT Filed: Dec. 1, 2011
(86) PCT No.: PCT/EP2011/006018

§ 371 Date: Aug. 15, 2013

(30) Foreign Application Priority Data
Dec. 2, 2010 (DE) 10 2010 053 022.0

(51) Int. Cl. G01C 19/56

(52) U.S. Cl. CPC G01C 19/56
USPC 73/504.12

(57) ABSTRACT

A device for measuring yaw rate, having a mechanical yaw rate sensor, which has an inert mass that can be set into a primary vibration along a primary axis by means of an excitation device and can be deflected along a secondary axis extending transversely with respect to the primary axis so that when a yaw rate occurs about a sensitive axis extending transversely with respect to the primary and to the secondary axis, said device carries out a secondary vibration excited by the Coriolis force. A sensor element detects an amplitude-modulated signal for the secondary vibration. A sigma-delta modulator has a low pass filter connected to the sensor element, a quantizer and a secondary actuator disposed in a feedback path for applying a force which counteracts the Coriolis force.

The invention relates to a device for measuring a yaw rate, comprising a mechanical yaw rate sensor, which has an inert mass that can be set into a primary vibration along a primary axis by means of an excitation device and can be deflected along a secondary axis extending transversely to the primary axis in such a way that when a yaw rate occurs about a sensitive axis extending transversely to the primary axis and transversely to the secondary axis, said device carries out a secondary vibration excited by the Coriolis force, further comprising at least one sensor element for detecting an amplitude-modulated sensor signal for the secondary vibration, still further comprising a sigma-delta modulator, which has a low pass filter connected to the sensor element, a quantizer downstream thereof, and a secondary actuator disposed in a feedback path via which a force counteracting the Coriolis force can be exerted on the mass, wherein the secondary actuator is connected to the quantizer via the feedback path in such a way that a feedback signal averaged over time compensates for the deflection of the mass in the direction of the secondary vibration.

Such a device is known from actual practice. It is used, for example, in driver assistance systems of vehicles, in electronic mechanisms which brake individual wheels in order stabilize the driving status of a vehicle, or in navigation systems. The yaw rate sensor of the device has an inert mass that is set by means of an excitation mechanism constantly into a primary vibration relative to a holder. The mass is suspended in such a way that when a yaw rate occurs about a sensitive axis extending transversely to the axis of the primary vibration, it is excited by the Coriolis force to a secondary vibration. The axis of the secondary vibration is aligned transversely to the primary vibration and transversely to the sensitive axis.

The secondary vibration is measured with the aid of a sensor element and converted into a corresponding analog electric sensor signal. Because the mass must be excited to the primary vibration in order to detect the yaw rate signal, the sensor signal is an amplitude-modulated signal. The carrier frequency of this signal corresponds to the frequency of the primary vibration.

The analog sensor signal is digitalized with the aid of a sigma-delta modulator. The latter has a low-pass filter and a 1-bit quantizer, with which the low-pass filtered analog signal having a frequency lying far above the necessary Nyquist frequency is scanned and digitalized. A high temporal resolution of the sensor signal is thus achieved. The output signal of the sigma-delta modulator is thus a binary signal with a high clock frequency, a so-called bitstream. Although this leads to a high quantization error or a loud quantization noise, the integration behavior of the sigma-delta modulator gives rise to the so-called noise-shaping effect, which alters the spectral shape of the noise and separates it from the signal to the greatest possible extent. The quantization noise can be suppressed very effectively with the low-pass filter.

In conjunction with a decimation of the signal, the high temporal resolution thereof is converted into a high amplitude resolution. Compared to other analog-digital conversion methods, this high resolution is achievable with good conversion speed, linearity, and above all with components of high integration density. Owing to the circuit structure and the functioning method, a union of a mechanical sensor and an electrical converter can also be achieved with the aid of the sigma-delta modulator.

To increase the linearity of the measurement, the device has a secondary actuator by means of which a force that counteracts the Coriolis force can be applied between the mass and the holder. The secondary actuator is connected to the quantizer via a feedback path in such a way that a feedback signal of the quantizer averaged over time compensates for the secondary vibration. The binary bitstream is used as a feedback signal. This means that the Coriolis force acting on the mass is almost completely compensated. Hence the insensitivity to noise and ultimately the resolution of the yaw rate signal are likewise increased.

The device has the disadvantage that the scanning frequency of the quantizer must be very high because of the low-pass filter, because the signal band to be scanned is now widened. The signal band is not just a small zone around the frequency of the primary vibration, but instead ranges from the baseband to the amplitude-modulated yaw rate signal. The scanning frequency is usually around one hundred times the frequency of the primary vibration. The device therefore has a correspondingly high power consumption.

The scanning frequency of the quantizer can be reduced by using a bandpass in place of the low-pass filter as a loop filter. In order to generate the necessary slope of the transfer function of the bandpass filter, the operational amplifiers employed must have a high amplification in the signal band so that they also function reliably at the input signal frequency. The high amplification, however, likewise results in a high power consumption. In addition the comparator is operated with a scanning frequency that usually corresponds to 4-8 times the resonance frequency of the mechanical sensor. This further increases the power consumption.

The object is therefore to create a device of the aforementioned type that enables a reliable and precise detection of the yaw rate signal with a low power consumption.

This object is achieved by the arrangement of a first modulation stage between the sensor element and the low-pass filter for shifting of the frequency band of the amplitude-modulated sensor signal in a lower frequency range, and by the arrangement of a second modulation stage in the feedback path between the quantizer and the yaw rate sensor for reversal of the frequency shift.

In an advantageous manner it is thus possible to operate the quantizer with a relatively low scanning rate, but nevertheless provide a low-pass filter as a loop filter. The device can thus be operated in an energy efficient manner. Through the compensation of the Coriolis force effected via the feedback path, a high linearity and bandwidth of the yaw rate measurement signal are possible.

The yaw rate measurement signal is furthermore largely independent of temperature influences.

The yaw rate sensor can be configured as a tuning fork gyroscope. Such a gyroscope is disclosed in Ajit Sharma et al.: “A High-Q In-Plane SOI Tuning Fork Gyroscope”, IEEE (2004), pp. 467-470.

However, the yaw rate sensor can also have a primary and a secondary mass, wherein the latter forms the inert mass. The primary mass is mounted on the holder in such a way that it can be deflected along a primary axis. The secondary mass is suspended from the primary mass in such a way that it can be deflected at transversely to the primary axis along a secondary axis relative to the primary axis. The assembly formed from the first and the secondary mass is operatively connected to an excitation mechanism, by means of which the assembly can be moved back and forth along the primary axis.

In an advantageous embodiment of the invention, the first modulation stage has a first input connected to a sensor signal output of the sensor element and a second input connected to a signal generator, wherein the second modulation stage has a first input connected to an output of the quantizer and a second output connected to the signal generator, and wherein the signal generator is configured for generating a control signal having at least one sine wave component. The low-pass filtered sensor signal and the sigma-delta modulation signal are therefore each modulated or multiplied in their associated modulation stage with the sine wave component of the control signal. Thus the sensor signal and the sigma-delta modulation signal can each be shifted to another frequency band in an energy efficient manner.

It is particularly advantageous if the excitation mechanism for generating the primary vibration has a primary actuator operatively connected to the mass, and if the primary actuator is synchronized with the sine wave signal generator. It is thus possible to use the same sine wave signal for controlling the primary actuator and for operating the modulation stages.

In a practical embodiment of the invention, the sigma-delta modulator has a scanning mechanism that is synchronized with the signal generator. The control signal provided by the sine wave signal generator can therefore also be used for clocking the scanning mechanism.

An example of embodiment of the invention is explained in more detail in the following, with reference to the drawing. Shown are:

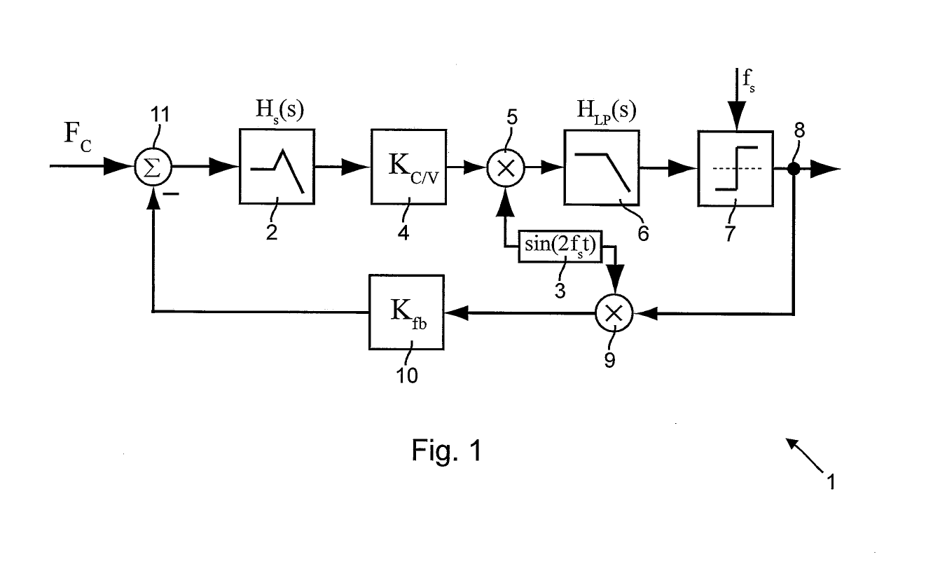

FIG. 1 a control engineering equivalent circuit diagram of a device for measuring a yaw rate, which has an electromechanical sigma-delta modulator, and

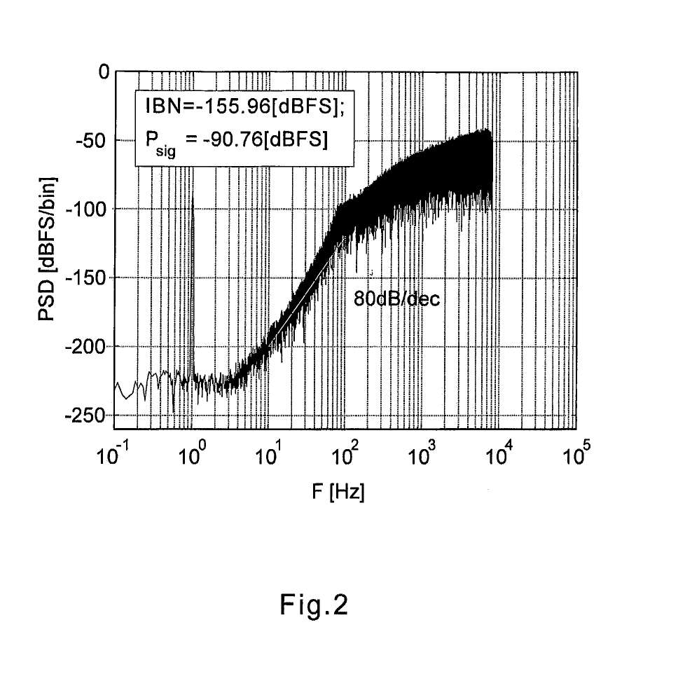

FIG. 2 an example of the power density spectrum of a yaw rate signal sigma-delta modulated and measured with the device, wherein the frequency is plotted in Hertz on the x-axis and the power output is plotted in dBFS/bin on the y-axis.

A device 1 for measuring a yaw rate has a mechanical yaw rate sensor 2 (only shown schematically in the drawing), which has a primary mass that is arranged on a holder in such a way that it can be deflected along a primary axis. An inert secondary mass is suspended from the primary mass in such a way that it can be deflected transversely to the primary axis along a secondary axis relative to the primary axis. The primary mass is operatively connected to an excitation mechanism by means of which the assembly consisting of the primary mass and the secondary mass can be moved back and forth parallel to the primary axis. For generating a control signal having a sine wave component for the excitation mechanism, the latter has a sine wave signal generator 3.

The primary vibration generated with the aid of the excitation mechanism has a constant amplitude and a constant frequency. The frequency of the primary vibration essentially matches the resonance frequency of the assembly.

When the yaw rate sensor 2 is deflected about a sensitive axis aligned transversely to the primary axis and transversely to the secondary axis, the Coriolis force

\vec{F}_{c}=−2·m·\vec{Ω}×\vec{ν}ₚ,

dependent on the primary mass m, the yaw rate Ω, and the velocity Vₚ of the primary mass acts on the secondary mass, via which force the secondary mass is set into a secondary vibration parallel to the secondary axis.

An electrical sensor signal dependent on the secondary vibration is detected with the aid of a sensor element 4, which has at least a first electrode arranged on the primary mass and at least a second electrode arranged on the secondary mass. Because the primary mass must be excited to the primary vibration in order to detect the sensor signal, the sensor signal is amplitude modulated. The carrier frequency of the sensor signal matches the frequency of the primary vibration.

A sensor signal output of the sensor element 4 is connected to a first input of a first modulation stage 5. A second input of the first modulation stage 5 is connected to the output of the sine wave signal generator 3. With the aid of the first modulation stage 5, the yaw rate signal is modulated in the baseband. The correspondingly modulated analog yaw rate signal is emitted at an output of the first modulation stage 5.

This output is connected to an input of a third order analog low-pass filter 6. In the low-pass filter 6, the signal is amplified and the quantization noise is suppressed and thus advantageously shaped from the baseband. The low-pass filter 6 has the following Laplace transformation.

$${H}_{LP} ( s ) = \frac{{s}^{3} + 4066 {s}^{2} + 9.827 \cdot {10}^{6} s + 1.185 \cdot {10}^{10}}{{s}^{3}}$$

An output of the analog low-pass filter 6 is connected to a first comparator input of a comparator 7 serving as a 1-bit analog digital converter or quantizer. A second input of the comparator, which is not shown in any greater detail in the drawing, lies on a predetermined electrical potential. The comparator 7 has a scanning mechanism not shown in any greater detail in the drawing, which scans the modulated signal present at the first comparator input synchronously to the sine wave control signal of the sine wave signal generator 3. To this end, the scanning mechanism has a clock signal input that is connected to the sine wave signal generator 3.

The sigma-delta modulation signal generated by the comparison of the scanned signal with the predetermined electrical potential is emitted in the form of a bitstream at the output 8 of the comparator 7.

The output 8 of the comparator 7 is connected via a feedback path to a first input of a second modulation stage 9. A second input of the second modulation stage 9 is connected to the output of the sine wave signal generator 3. With the aid of the second modulation stage 9, the sigma-delta modulation signal is modulated up to the input frequency. The signal thus obtained is amplified in order to control a secondary actuator 10 disposed in the feedback path. Said actuator applies a force in proportion to the sigma-delta modulation signal modulated up to the input frequency between the primary mass and the secondary mass, which counteracts the Coriolis force F_{c}. This is schematically represented in FIG. 1 by an adder 11. The deflection of the primary mass averaged over time is compensated with the aid of the force generated by the secondary actuator 10. For processing the yaw rate signal, the device therefore has a closed electromagnetic control circuit.

In order to enable high sensitivity and resolution of the yaw rate signal, the resonance frequencies of the primary mass and of the secondary mass can be adapted to one another.

An example of the power density spectrum of a sigma-delta modulation signal present at the output 8 of the comparator 7 is graphically reproduced in FIG. 2. The typical noise shaping behavior of the sigma-delta converter, wherein the resonance disappears almost completely, is clearly discernible.

1. A device for measuring a yaw rate, comprising a mechanical yaw rate sensor, which has an inert mass that can be set into a primary vibration along a primary axis by means of an excitation device and which can be deflected along a secondary axis extending transversely to the primary axis in such a way that when a yaw rate occurs about a sensitive axis extending transversely to the primary axis and transversely to the secondary axis, said device carries out a secondary vibration excited by the Coriolis force, further comprising at least one sensor element for detecting an amplitude modulated sensor signal for the secondary vibration, and still further comprising a sigma-delta modulator which has a low pass filter connected to the sensor element, a quantizer connected downstream thereof, and a secondary actuator disposed in a feedback path via which a force counteracting the Coriolis force can be exerted on the mass, wherein the secondary actuator is connected to the quantizer via the feedback path in such a way that a feedback signal averaged over time compensates for the deflection of the mass in the direction of the secondary vibration, wherein for shifting of the frequency band of the amplitude-modulated sensor signal in a lower frequency range, a first modulation stage is disposed between the sensor element and the low-pass filter, and further characterized in that a second modulation stage is disposed in the feedback path between the quantizer and the yaw rate sensor for reversal of the frequency shift.

2. The device as in claim 1, wherein the first modulation stage has a first input connected to a sensor signal output of the sensor element and a second output connected to a signal generator, further characterized in that the second modulation stage has a first input connected to an output of the quantizer and a second output connected to the signal generator, and still further characterized in that the signal generator is configured for generating a control signal having at least one sine wave component.

3. The device as in claim 1, wherein the excitation mechanism for generating the primary vibration has a primary actuator operatively connected to the mass and further characterized in that the primary actuator is synchronized with the signal generator.

4. The device as in claim 2, wherein that the sigma-delta modulator has a scanner mechanism, which is synchronized with the signal generator.
